(19) United States
(12) Patent Application Publication
(10) Pub. No.: US 2005/0259593 A1
(43) Pub. Date: Nov. 24, 2005

(54) Network cabling method and device

(75) Inventors: Chang-Lien Wu, Taichung City (TW); Jiann-Shiun Tung, Taichung City (TW)

Correspondence Address: TROXELL LAW OFFICE PLLC, SUITE 1404, 5205 LEESBURG PIKE, FALLS CHURCH, VA, 22041, US

(73) Assignee: Realtek Semiconductor Corp.

(21) Appl. No.: 11/168,467

(22) Filed: Jun. 29, 2005

Related U.S. Application Data
(63) Continuation-in-part of application No. 10/640,033, filed on Aug. 14, 2003.

(30) Foreign Application Priority Data
Jul. 2, 2004 (TW) 093119961

(51) Int. Cl. H04L 12/26

(52) U.S. Cl. 370/252

(57) ABSTRACT

An apparatus is used for network cabling in a communication system. The communication system comprises a first endpoint and a second endpoint communicating with the first endpoint over a network medium. The apparatus is in the first endpoint and comprises: a connection interface, connecting to the network medium, having a first configuration and a second configuration, the connection interface being used for alternatively switching to the first configuration or the second configuration according to a switching signal; and a control circuit configured to detect a link signal from the second endpoint to determine whether the configuration of the switching interface is correct, and output the switching signal to control an operation of the connection circuit according to a predetermined sequence data when the configuration of the switching interface is incorrect.

The application is a continuation-in-part of application Ser. No. 10/640,033, filed Aug. 14, 2003.

### BACKGROUND OF INVENTION

1. Field of the Invention

The present invention generally relates to a communication system. More particularly, the present invention relates to a method and an apparatus for network cabling in the communication system.

2. Description of the Prior Art

The role of network transmission medium in network communications has not been much looked upon as that of communication protocol and communication equipments. However, it has a decisive importance in that the quality of communication that usually relies heavily on the cable and connectors that is used as the network transmission medium. The basic elements of the network transmission medium generally consists: coaxial cable, twisted-pair cables, and fiber-optics, etc. and the present invention is intended to improve a network device using the twisted-pair cables.

Twisted-pair cables are cables consist of independently insulated wires that are twisted around each other to reduce interference such as noise and/or crosstalk. Electromagnetic fields are generated when electrons flow through a wire and will cause interference with other conducting wires. If the positive signal and the negative signal are twisted to each other, the electromagnetic field generated by each wire can cancel out each other and thus reduce interference. In the Ethernet network, over 70% of the network is built with unshielded twisted-pair cable (UTP). Due to the inexpensiveness and the easiness of setting up, both the 10 Mbps Ethernet network standard (10BaseT) and the 100 Mbps high speed Ethernet network standard (100BaseTX) uses twisted-pair cable.

A connector is also needed for the twisted-pair cable to connect an endpoint to an intermediate-point endpoint or an intermediate-point endpoint to another intermediate-point endpoint during the connection of Ethernet network. Please refer to FIG. 1A and FIG. 1B. FIG. 1A and FIG. 1B individually represents the top view and the cutaway view of the connector of the Ethernet network connection. RJ-45 connectors are used by UTP that conforms to the 10BaseT and the 100BaseT standards. A general RJ-45 connector is of the 8P8C type. 8P stands for 8 positions which are the 8 slots. 8C stands for 8 gold-plated contacts which are the 8 pins. Although there are 8 pins on the RJ-45 connector, in the application of Ethernet network, usually only the two sets of wires that belongs to pins 1, 2 and pins 3, 6 are utilized. As for other applications, the other two sets can be used for telephone line, fax, etc, for information integration.

In corresponding to the RJ-45 connector used on the UTP by any two endpoints connecting cables, either endpoint of the Ethernet network would have an RJ-45 slot. The RJ-45 slot has 8 positions that correspond to the connector pins of the RJ-45 connector, and only positions 1, 2 and 3, 6 of the RJ-45 slot are utilized. Different definitions are defined for the pins for RJ-45 of different endpoints on the Ethernet network. For example, opposite definitions for the pins are defined for the RJ-45 slot of the intermediate-point hub and the end-point network card. However, the same pin definitions are defined for both the RJ-45 slots for the switch hub and the network card. Therefore, when connecting two endpoints with UTP on the Ethernet network, one should consider the definitions of the pins for the RJ-45 slots on the two endpoints, in order to decide whether to utilize Straight-through UTP or Crossover UTP to conform to the specification of the Ethernet.

Please refer to FIG. 2A and FIG. 2B. FIG. 2A and FIG. 2B individually represents schematic diagrams showing Straight-through UTP and Crossover UTP. In FIG. 2A, the RJ-45 slot of the hub uses pins 1, 2 as its receiving end (RX+, RX−) and pins 3, 6 as its transmitting end (TX+, TX−), while the RJ-45 slot of the network card uses pins 1, 2 as its transmitting end (TX+, TX−) and pins 3, 6 as its receiving end (RX+, RX−). Since the two are exactly opposite in definition, to conform to the specification of the Ethernet in that the transmitting end (TX) should correspond to the receiving end (RX), the hub and the network card utilizes Straight-through UTP for their connection. In FIG. 2B, due to the same definitions are defined for each of the hubs, Crossover UTP is utilized to conform to the specification of the Ethernet.

In practice, the users usually fail to connect any two endpoints on the Ethernet due to the confusion of which configuration (Straight-through or Crossover) of UTP to use.

One of prior art is U.S. Pat. No. 6,175,865. U.S. Pat. No. 6,175,865 discloses that the media connectors of a node interface device is controlled by a pseudo-random manner.

This invention proposes a method and device for network cabling. It allows for the usage of the same configuration of network cables to be used when connecting two endpoints, in order to avoid the confusions during actual cabling.

### SUMMARY OF INVENTION

It is therefore one of the objectives of the claimed invention to provide a method and an apparatus for network cabling, which allows for the usage of a plurality of configurations of network cable in connecting networks to prevent confusions of the users during cabling.

In accordance with one aspect of the present invention, this invention provides a method for network cabling in a communication system, the communication system comprising a first endpoint and a second endpoint communicating with the first endpoint over a network medium, the method comprising: providing an interface of the first endpoint, wherein the interface of the first endpoint has a first configuration and a second configuration; detecting a link signal from the second endpoint to determine which one of the first and the second configurations of the first endpoint is correct; switching back and forth between the first and the second configurations according to a predetermined sequence data when the configuration of the first endpoint is incorrect; and stopping switching the configuration of the interface when the configuration of the first endpoint is correct.

In accordance with one aspect of the present invention, this invention provides an apparatus for network cabling in a communication system, the communication system comprising a first endpoint and a second endpoint communicating with the first endpoint over a network medium, the apparatus being within the first endpoint and comprising: a connection interface, connecting to the network medium, having a first configuration and a second configuration, wherein the connection interface is used for switching back and forth the first and the second configurations according to a switching signal; and a control circuit utilized to detect a link signal from the second endpoint to determine whether the configuration of the switching interface is correct, and output the switching signal to control an operation of the connection circuit according to a predetermined sequence data when the configuration of the switching interface is incorrect.

### BRIEF DESCRIPTION OF THE DRAWINGS

The details of the present invention will be more readily understood from a detailed description of the preferred embodiments taken in conjunction with the following figures.

FIG. 1A and FIG. 1B individually represents the top view and the cutaway view of the connector of the Ethernet network connection;

FIG. 2A and FIG. 2B individually represents schematic diagrams showing Straight-through configuration and Crossover configuration;

FIG. 3 is a schematic diagram of network cabling of the preferred embodiment of this invention; and

FIG. 4 is a schematic diagram of network cabling of another preferred embodiment of this invention.

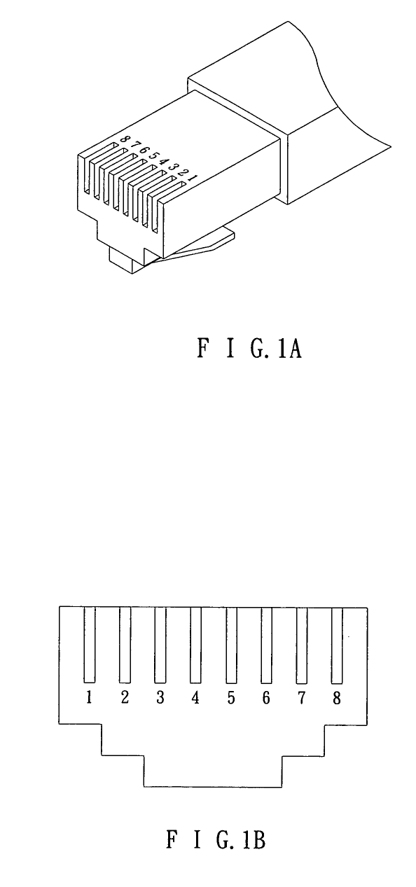

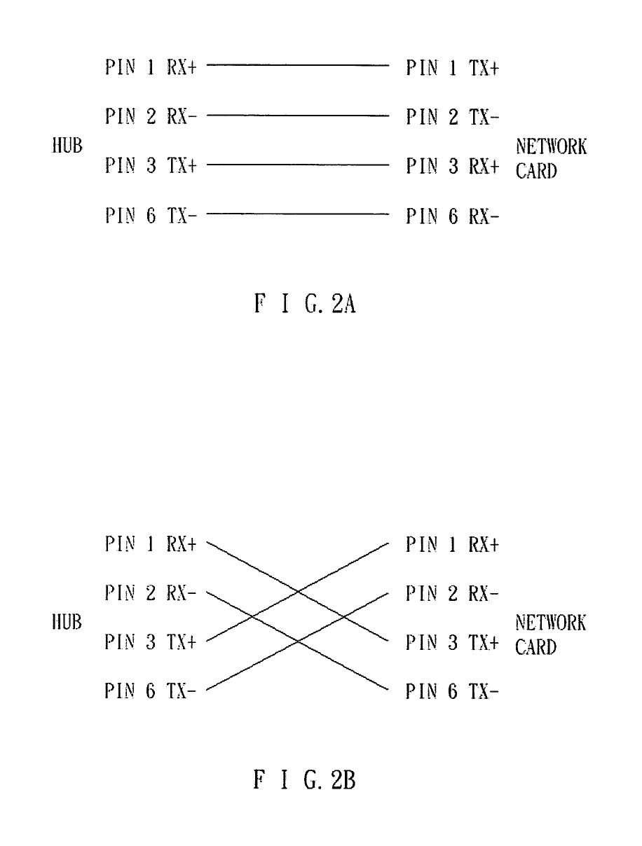

### DETAILED DESCRIPTION

Due to the reason that users often encounter the problem of not knowing which configuration (Straight-through or Crossover) of network cabling to use when connecting any two endpoints on the Ethernet network, and therefore fail to connect the two endpoints, this invention provides a solution for the above mentioned problem.

To solve the mistake of using wrong cabling configuration when connecting two endpoints, this invention provides an interface that is placed on the endpoint. This interface is a switching device that is capable of switching between different cabling configuration, such as Straight-through cabling configuration or Crossover cabling configuration.

In this embodiment, the interface, with different controlling methods, can provide another configuration (Straight-through or Crossover cabling configuration) when a wrong configuration of network cable is connected to the endpoint.

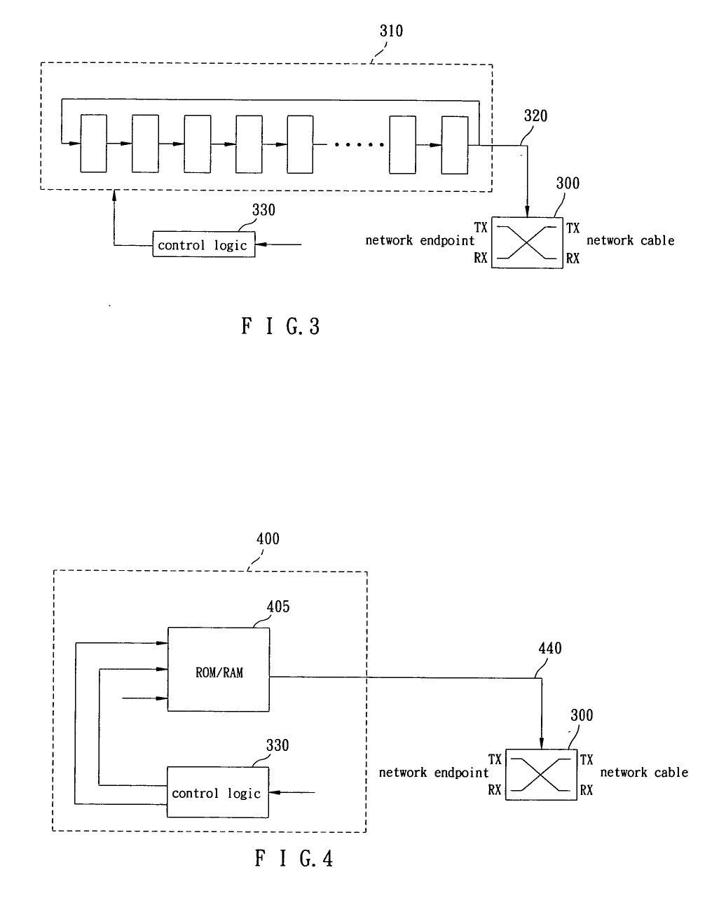

Please refer to FIG. 3. FIG. 3 is a schematic diagram of network cabling of the preferred embodiment of this invention. The interface 300 that is placed on the endpoint can provide a Straight-through or Crossover cabling configuration in between endpoints and network cables. When a wrong cabling configuration of network cable is used at a endpoint, the interface 300 is used to change the cabling configuration between endpoint and network cable according to a sequence data which could be generated by power bouncing, thermal noise, memory default value, timer, random generator, or software random generator . . . etc. Because the sequence data, which is dependent on the power bouncing or thermal noise or software, is a conventional technique, the detailed description is omitted.

In an embodiment, the interface 300 is controlled by a predetermined sequence for providing Straight-through or Crossover cabling configuration. In a preferred embodiment, the predetermined sequence is a fixed sequence. A control signal 320 outputted from a shift register 310 with the predetermined sequence is controlled by a control logic 330. This control signal 320 determines the interface 300 to provide Straight-through or Crossover cabling configuration. Also, at this time, the interface 300 will maintain its present mode if the transmission between the endpoint that employs this interface 300 and another endpoint is normal. Otherwise, if the transmission is abnormal, which causes failure of connection, the interface 300 will alternatively switch to provide other cabling configuration until normal transmission is achieved between the endpoint that employs this interface 300 and another endpoint.

Please refer to FIG. 4. FIG. 4 is a schematic diagram of network cabling of another preferred embodiment of this invention. In FIG. 4, this invention provides another way of network cabling through an interface 300 that is capable of switching between different cabling configurations. In the embodiment, this control unit 400 comprises a control logic 330 and a memory 405. The memory 405 can be RAM or ROM or other type of storage device. The control unit 400 can provide a detection mechanism to detect a transmission between the endpoint that employs this interface 300 and another endpoint. The detection mechanism is provided by the following scheme: control logic 330, according to the input from the control unit 400, generates an address signal 410 and a reading signal 420. The memory 405 outputs a data signal 440 to the interface 300 according to the address signal 410. It is detected the transmission between the two endpoints to determine whether the cabling configuration provided by the interface 300 is correct (i.e., the control logic 330 receives a link signal generated from another endpoint). If the transmission between the interface 300 and another endpoint is normal, interface 300 will sustain its present cabling mechanism (i.e., the interface stops switching back and forth between the straight-through and crossover cabling configurations). Otherwise, interface 300 will switch its cabling configuration according to the data signal 440 outputted from the memory 405 until the transmission between two endpoints is correct. When the transmission between the two endpoints is correct, the interface 300 of the endpoint will stop switching its cabling configuration. In an embodiment, the size of the memory 405 is larger than 256 bits.

Therefore by placing an interface at either a network interface card (NIC), a hub or other endpoint, this interface can correct the cabling mechanism between the endpoint and network cable if the cabling mechanism of the corresponding network cable does not match with the endpoint, i.e., the user can use either Straight-through or Crossover RJ-45 cable to connect a network interface card (NIC) with a hub or a hub with another hub, etc.

In general, this invention provides a method and a device for network cabling by placing an interface on the endpoint which functions as a switch for enabling different cabling mechanism between an endpoint and a network cable. With this, corrections can be made on the cabling mechanism between an endpoint and a network cable if a cabling mistake occurred. Therefore, this invention enables the usage of the same cabling configuration when connecting any two endpoints.

Those skilled in the art will readily observe that numerous modifications and alterations of the device may be made while retaining the teachings of the invention. Accordingly, that above disclosure should be construed as limited only by the metes and bounds of the appended claims.

1. A method for network cabling in a communication system, the communication system comprising a first endpoint and a second endpoint communicating with the first endpoint over a network medium, the method comprising:
providing an interface of the first endpoint, wherein the interface of the first endpoint has a first configuration and a second configuration;
switching to one of the first and the second configurations of the interface of the first endpoint within a predetermined period, and detecting a communication between the first endpoint and the second endpoint;
switching back and forth between the first and the second configurations according to a predetermined sequence data when the communication between the first endpoint and the second endpoint are failure; and
stopping switching the configuration of the interface when the communication between the first endpoint and the second endpoint is successful.

2. The method of the claim 1, wherein the predetermined sequence data is generated according to at least one of power bouncing, thermal noise, memory default value, timer, and random generator.

3. The method of the claim 1, wherein one of the first and the second endpoints is a first switch hub and the other is a network interface card (NIC) or a second switch hub.

4. The method of the claim 1, wherein the predetermined sequence data is stored in a memory.

5. The method of the claim 1, wherein the first and the second configurations are a straight-through configuration and a crossover configuration, respectively.

6. A method for network cabling in a communication system, the communication system comprising a first endpoint and a second endpoint communicating with the first endpoint over a network medium, the method comprising:
providing an interface of the first endpoint, wherein the interface of the first endpoint has a first configuration and a second configuration;
detecting a link signal from the second endpoint to determine which one of the first and the second configurations of the first endpoint is correct;
switching back and forth between the first and the second configurations according to a predetermined sequence data when the configuration of the first endpoint is incorrect; and
stopping switching the configuration of the interface when the configuration of the first endpoint is correct.

7. The method of the claim 6, wherein the predetermined sequence data is generated according to at least one of power bouncing, thermal noise, memory default value, timer, and random generator.

8. The method of the claim 6, wherein the predetermined sequence data is stored in a memory.

9. The method of the claim 6, wherein the first and the second configurations are a straight-through configuration and a crossover configuration, respectively.

10. An apparatus for network cabling in a communication system, the communication system comprising a first endpoint and a second endpoint communicating with the first endpoint over a network medium, the apparatus being within the first endpoint and comprising:
a connection interface, connecting to the network medium, having a first configuration and a second configuration, wherein the connection interface is used for switching back and forth the first and the second configurations according to a switching signal; and
a control circuit utilized to detect a link signal from the second endpoint to determine whether the configuration of the switching interface is correct, and output the switching signal to control an operation of the connection circuit according to a predetermined sequence data when the configuration of the switching interface is incorrect.

11. The apparatus of the claim 10, wherein the predetermined sequence data is stored in a memory.

12. The apparatus of the claim 10, wherein one of the first and the second endpoints is a switch hub and the other is a network interface card (NIC).

13. The apparatus of the claim 10, wherein the first and the second endpoints are switch hubs.

14. The apparatus of the claim 10, wherein the control circuit comprises:
a storage unit utilized to store the predetermined sequence data and output the switching signal according to a control signal; and
a control logic utilized to detect a link signal from the second endpoint to determine whether the configuration of the switching circuit is correct, and output the control signal when the configuration of the switching circuit is incorrect.

15. The apparatus of the claim 14, wherein the control signal comprises an address signal and a read signal.

16. The apparatus of the claim 15, wherein the storage unit is a read only memory (ROM) or a random access memory (RAM).

17. The apparatus of the claim 15, wherein a size of the storage unit is approximately larger than 256 bits.

18. The apparatus of the claim 10, wherein the control circuit comprises:
a shift register utilized to output the switching signal according to a control signal; and
a control logic utilized to detect a link signal generated from the second endpoint, and output the control signal when the control logic does not detect the link signal.

19. The apparatus of the claim 10, wherein the predetermined sequence data is generated according to at least one of power bouncing, thermal noise, memory default value, timer, and random generator.
